(19) United States
(12) Patent Application Publication
(10) Pub. No.: US 2014/0015855 A1
(43) Pub. Date: Jan. 16, 2014

(54) SYSTEMS AND METHODS FOR CREATING A SEMANTIC-DRIVEN VISUAL VOCABULARY

(71) Applicants: Bradley Scott Denney, Irvine, CA (US); Juwei Lu, Irvine, CA (US); Dariusz T. Dusberger, Irvine, CA (US); Sholeh Forouzan, Irvine, CA (US)

(72) Inventors: Bradley Scott Denney, Irvine, CA (US); Juwei Lu, Irvine, CA (US); Dariusz T. Dusberger, Irvine, CA (US); Sholeh Forouzan, Irvine, CA (US)

(73) Assignee: CANON KABUSHIKI KAISHA, Tokyo (JP)

(21) Appl. No.: 13/550,357

(22) Filed: Jul. 16, 2012

(51) Int. Cl. G09G 5/00

(52) U.S. Cl. 345/629

(57) ABSTRACT

Systems and methods for clustering descriptors in a space of visual descriptors to generate augmented visual descriptors in an augmented space that includes semantic information, wherein the augmented space of the augmented descriptors includes both visual descriptor-to-descriptor dissimilarities and semantic label-to-label dissimilarities; and cluster the augmented visual descriptors in the augmented space based at least in part on a dissimilarity measure between augmented visual descriptors in the augmented descriptor space.

### BACKGROUND

1. Field

The present disclosure relates to visual analysis of images.

2. Background

In the field of image analysis, images are often analyzed based on visual features. The features include shapes, colors, and textures. The features in the image can be detected and the content of the image can be guessed from the detected features. However, image analysis can be very computationally expensive.

### SUMMARY

In one embodiment, a method for clustering descriptors comprises augmenting visual descriptors in a space of visual descriptors to generate augmented visual descriptors in an augmented space that includes semantic information, wherein the augmented space of the augmented descriptors includes both visual descriptor-to-descriptor dissimilarities and semantic label-to-label dissimilarities; and clustering the augmented visual descriptors in the augmented space based at least in part on a dissimilarity measure between augmented visual descriptors in the augmented descriptor space.

In one embodiment, a system for clustering descriptors comprises a computer-readable medium configured to store visual descriptors; and one or more processors configured to cause the system to determine distances between the visual descriptors based on distances in visual dimensions and distances in semantic dimensions, and cluster the visual descriptors based on the distances.

In one embodiment, one or more computer-readable media store instructions that, when executed by one or more computing devices, cause the one or more computing devices to perform operations comprising adding semantic information to visual descriptors, thereby generating augmented descriptors, wherein the visual descriptors are described by visual dimensions in a visual space, and the augmented descriptors are described by semantic dimensions and visual dimensions in an augmented space; and clustering the augmented descriptors in the augmented space, thereby generating augmented clusters.

### BRIEF DESCRIPTION OF THE DRAWINGS

FIG. 1 is a block diagram that illustrates an example embodiment of a method for generating clusters of descriptors.

FIG. 2 illustrates an embodiment of the augmented space.

FIG. 3 illustrates an embodiment of the augmented space.

FIG. 4 illustrates an embodiment of a k-means-like method for clustering descriptors.

FIG. 5 illustrates an example embodiment of a method for cluster agglomeration.

FIG. 6 illustrates example embodiments of agglomerated clusters.

FIG. 7 illustrates an example embodiment of a method for generating a visual vocabulary.

FIG. 8 illustrates an example embodiment of a method for generating a visual vocabulary.

FIG. 9 illustrates an example embodiment of visual words that are generated based on descriptors that are clustered based on labels.

FIG. 10 illustrates an example embodiment of visual words that are generated based on descriptors that are clustered based on labels.

FIG. 11 illustrates an embodiment of an ontology and a similarity table.

FIG. 12 illustrates an embodiment of a method for generating a semantic average for two or more labels.

FIG. 13 illustrates a relationship between a label score and a regularization parameter.

FIG. 14 is a block diagram that illustrates an example embodiment of a system for generating a visual vocabulary.

FIG. 15A is a block diagram that illustrates an example embodiment of a system for generating a visual vocabulary.

FIG. 15B is a block diagram that illustrates an example embodiment of a system for generating a visual vocabulary.

### DESCRIPTION

The following disclosure describes certain explanatory embodiments. Additionally, the explanatory embodiments may include several novel features, and a particular feature may not be essential to practice the systems and methods described herein.

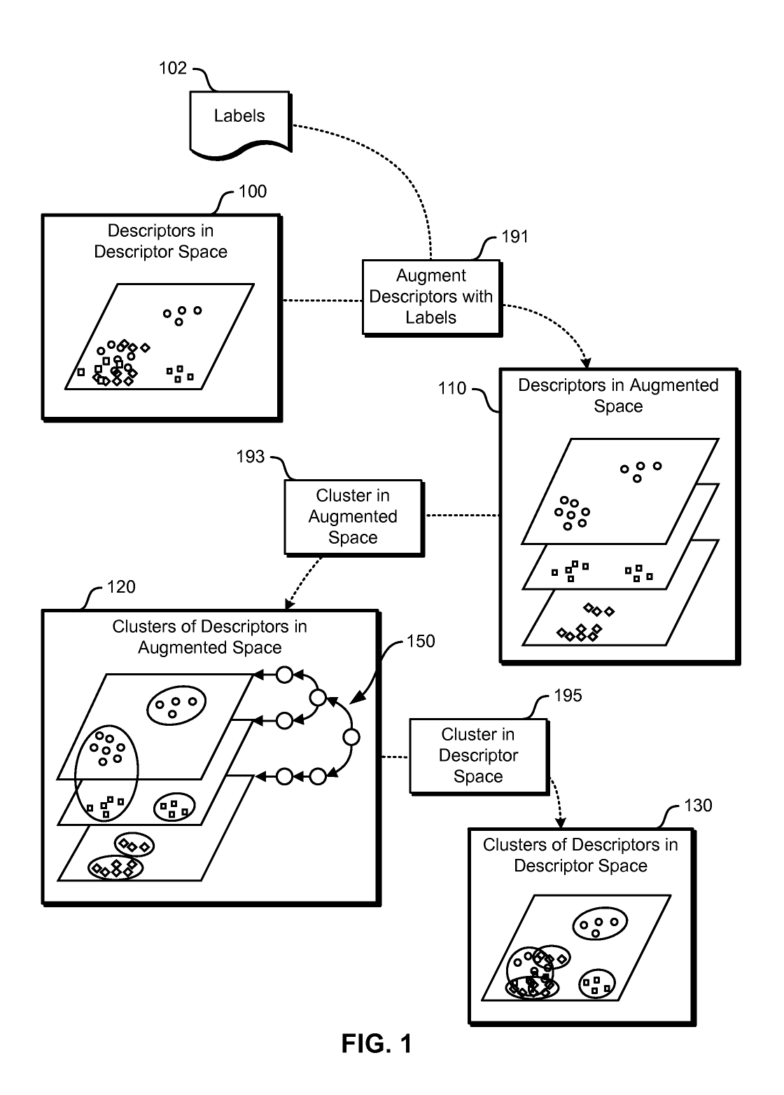

FIG. 1 is a block diagram that illustrates an example embodiment of a method for generating clusters of descriptors. FIG. 1 shows a collection of descriptors in descriptor space 100 and associated labels 102 for the descriptors. For example, respective labels (e.g., semantic labels) of images could be attributed to the whole image, so every descriptor in an image is attributed to the respective label(s). The collection of descriptors in descriptor space 100 (the descriptor space may be a high-dimensional vector space) is augmented 191 with the associated labels 102 to generate a collection of descriptors in augmented space 110. The augmented space may have a higher dimensionality and/or a different dimensionality than the descriptor space, and the dimensions in the augmented space may enhance the discriminability of the descriptors. The descriptors in augmented space are clustered 193 to generate clusters of descriptors in augmented space 120. The clustering in augmented space may also be based on an ontology 150 (e.g., a hierarchy) of the labels. Then, the clusters of descriptors in the augmented space 120 are clustered in descriptor space 195 to generate a collection of descriptors in descriptor space 130.

Note that sometimes semantic labels are assigned to one or more specific regions of an image (e.g., a label is assigned to some regions and not to other regions). Thus, an image may include labels that are generally assigned to the whole image and labels that are assigned to one or more regions in the image. The regions may be disjoint or overlapping. Some images may not be labeled at all. In some embodiments, if a descriptor extracted from an image is in one or more labeled regions of the image, then the descriptor is associated with the one or more labels that are assigned to the one or more regions. Else, if the descriptor is not from a labeled region but the image has one or more generally assigned labels, then the descriptor is associated with the one or more generally assigned labels. If the descriptor is not from a labeled region and the image does not have any generally assigned labels, then the descriptor may not be initially used for clustering in the augmented space. In some embodiments, the descriptor is associated with all of the labels (if any) of the regions that include the descriptor and with all of the generally assigned labels (if any) of the image from which the descriptor was extracted. Other embodiments may use other techniques to associate labels with descriptors.

The augmented space 110, which may contain additional dimensions that encode semantic information, is a descriptor space that is transformed to make the application of certain distance metrics in the augmented space 110 easier, enhance the discriminability of the descriptors, make the descriptors easier to compare and analyze, preserve descriptor-to-descriptor dissimilarities, and/or preserve label-to-label dissimilarities. In some embodiments, the preservation is approximate. For example, descriptors can be augmented by choosing a function such that the Euclidean distance or dot product between any pair of descriptors augmented via the augmentation function mapping is similar to the semantic label distance or the semantic similarity, respectively, between the pair of descriptors. Thus, the function can be chosen based on some parametric form. In addition, the function may be subject to some smoothness constraints. In some embodiments, the dimensions of the augmented space 110 are not explicitly constructed, but instead a distance function describing the augmented space 110 can be constructed as a combination of distances in both the descriptor space and the label space.

In another embodiment, the augmented space 110 is a transformed version of the descriptor space, such that a distance measure in the augmented space 110 best approximates the semantic distances of the descriptors. In embodiments where unlabeled image descriptors are used, the semantic distances may be assumed to be sufficiently distant from all other labeled descriptors.

For example, to construct the augmented space 110 in block 191, some embodiments may seek the function parameters Θ that minimize the following objective function J(Θ),

$$J ( Θ ) = {\sum }_{i} {\sum }_{j} ϕ \{ ρ ( f ( {x}_{i} ; Θ ) , f ( {x}_{j} ; Θ ) ) , {ρ}_{s} ( {l}_{i} , {l}_{j} ) \} ,$$

where ρ(•,•) is a distance in the augmented space, ρ_{S}(lᵢ,lⱼ) is the semantic distance between the label of descriptor i and the label of descriptor j, and φ is a dissimilarity measure defined on the metrics. One example of this embodiment is

$$J ( Θ ) = {\sum }_{i} {\sum }_{j} {\vert ρ ( f ( {x}_{i} ; Θ ) , f ( {x}_{j} ; Θ ) ) - {ρ}_{s} ( {l}_{i} , {l}_{j} ) \vert}^{2} .$$

In some embodiments a version of this objective is used so that the distance similarity between the augmented space and the semantic space is desired to be maintained (minimize the error) only when the semantic similarity is small. Thus, these embodiments do not penalize mismatches in semantic space and augmented space distances when the semantic concepts are very different.

In some embodiments the objective function may not provide the desired effect because the objective function will focus on gross mismatches in the mapping. Thus more sophisticated embodiments are possible. For example, the function φ{•} may limit the range of the errors so that all errors over a certain bound are treated equally.

In some embodiments, the augmented space distance is a Euclidean distance. For example, the function could be a linear transformation

f(x;Θ)=Θx,

where x is a d×1 descriptor column vector and Θ is an m×d matrix, where m>d.

In some example embodiments, the function is a non-linear function such as one taking on the form

f(x;Θ)=wⱼκ(pⱼ,x),

where Θ={W, P}, wⱼ is the j-th column of W, pⱼ is the j-th column of P, and κ(•,•) is some kernel function. One specific embodiment taking on this form, for example, is

f(x;Θ)=W^{T}e^{Px}.

In these example embodiments, the parameters of the augmentation function may need to be learned. This learning may be accomplished through the optimization of the objective function, and additional constraints may be added to this optimization. For example, the linear transformation may be constrained to set a lower bound on the matrix conditioning number, and the matrix may also be constrained via an additional regularization term that might encourage sparser solutions over less sparse solutions, lower rank solutions over higher rank solutions, or, more generally, less complex solutions over more complex solutions. For the non-linear forms, for example, some constraints on function smoothness may be used in addition to the conditions mentioned above.

In different embodiments, the augmented space 110 need not be explicitly defined or determined. In these embodiments, an augmented space distance is defined using a combination of the descriptor dissimilarity and the semantic dissimilarity. As an example, an augmented space distance can be defined as a function of the descriptor distance and the semantic label distance:

ρᵢⱼ=g[ρ(xᵢ,xⱼ),ρₛ(lᵢ,lⱼ)].

An example embodiment of this form is

ρᵢⱼ=ρ(xᵢ,xⱼ)+λρₛ(lᵢ,lⱼ),

where λ is a parameter that can be determined experimentally, for example based on cross validation or based on the resulting clustering quality scores that are obtained.

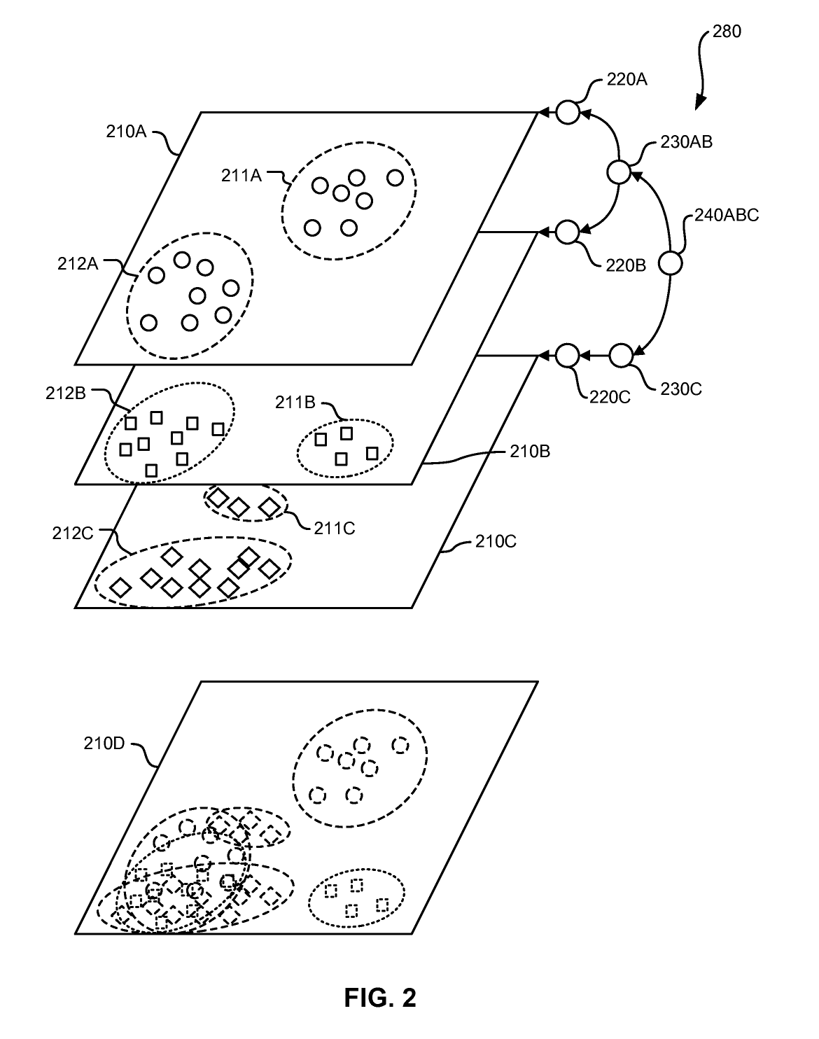

FIG. 2 illustrates an embodiment of the augmented space. FIG. 2 shows three planes containing descriptors 210A, 210B, and 210C. Each of these planes 210A-C corresponds to a semantic concept given by a label in a hierarchy of labels 280 (which is also referred to herein as a hierarchy 280 and is an example of an ontology). Thus, planes 210A, 210B, and 210C correspond to labels 220A, 220B, and 220C, respectively. In addition, label 220A and label 220B share the same immediate parent concept label 230AB in the hierarchy 280, while label 220C has the parent concept label 230C. Both label 230AB and label 230C share the same parent concept label 240ABC in the hierarchy 280. Also, each plane in this example includes two clusters: plane 210A includes clusters 211A and 212A, plane 210B includes clusters 211B and 212B, and plane 210C includes clusters 211C and 212C. Additionally, plane 210D shows the descriptors as they appear in the original descriptor space, when the clusters in the label space planes are projected to the original descriptor space. FIG. 2 illustrates that, if semantic labels are considered to be an additional dimension, then it may be easier to analyze the clusters on a label-by-label basis.

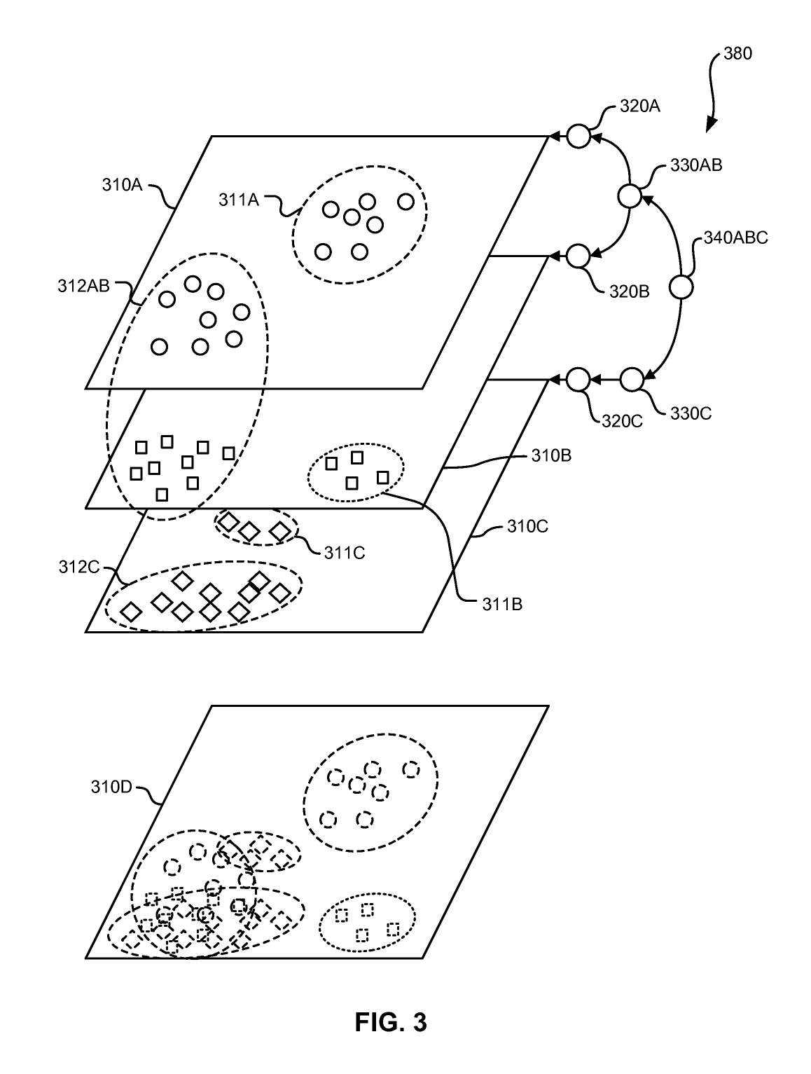

FIG. 3 illustrates an embodiment of the augmented space. FIG. 3 shows the same descriptors as FIG. 2, but clustering occurs not only in the descriptor space and in the planes of the labels in augmented space, but also across the planes 310A-C of the labels 320A-C. This can be accomplished by incorporating the semantic distances of the labels, which can be determined from the hierarchy of the labels 380. In this example, cluster 312AB spans planes 310A and 310B corresponding to semantic concept labels 320A and 320B because these concept labels are sufficiently similar, while clusters 311C and 312C remain distinct because concept label 320C is sufficiently different from concept labels 320A and 320B. Also, in FIG. 3 the projection of the augmented space clusters into descriptor space is shown in plane 310D.

Referring again to FIG. 1, in block 193 the descriptors are clustered in augmented space. Some embodiments explicitly construct the augmented space, and some embodiments do not. However, to cluster the descriptors in augmented space in embodiments where the augmented space is not explicitly constructed, but rather the descriptor and semantic dissimilarities are combined to create an augmented space metric, creating cluster centroids using some standard clustering methods, such as k-means, may not be straightforward because the constructed augmented space 110 may not explicitly be a vector space where vector averaging can be easily performed to find the cluster centroids.

However, the labels can be considered as a vector space by treating the labels as sparse binary vectors where each dimension corresponds to a different semantic label. Also, semantic averaging can be performed, which can be used to perform semantic clustering. In addition, the semantic clustering may be combined with the descriptors in the augmented descriptor space to achieve clustering in the augmented space. Also, some embodiments implement a k-means-like method, using a distance in the augmented space that is the weighted sum of the descriptor distance and the semantic distance.

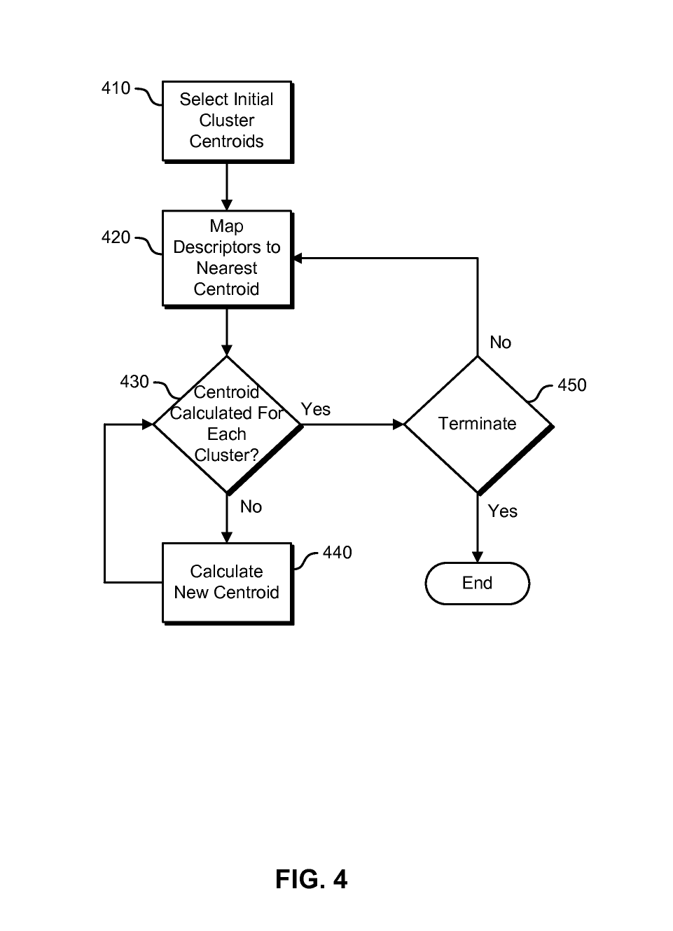

An embodiment of a k-means-like method for clustering labeled descriptors is shown in FIG. 4. Other embodiments of this method and the other methods described herein may omit blocks, add blocks, change the order of the blocks, combine blocks, and/or divide blocks into separate blocks. Additionally, one or more components of the systems and devices described herein may implement the method shown in FIG. 4 and the other methods described herein.

The method includes an initialization phase in block 410, where k distinct labeled descriptors are chosen at random as initial cluster centroids. In some embodiments, the k labeled descriptors are selected to increase the diversity of the initial cluster centroids, for example using k-means++. The initial assigning of a selected labeled descriptor as a cluster centroid may be accomplished by randomly selecting one of the labels assigned to a descriptor from the label assignment binary vector of the descriptor. In order to make the label as specific as possible, if a descriptor has multiple labels and the selected label has one or more child labels assigned to the descriptor (as defined by a label hierarchy), then the cluster label may be changed to a selected one of the child labels. In some embodiments, the child label selection is done at random. This process may be repeated until the selected label has no child labels. This process provides a more specific label as the initial cluster label centroid. Care must be taken to ensure that no two identical centroids (descriptors and selected labels) are repeated in the initial clusters.

Next in block 420, all labeled descriptors are mapped to the nearest centroid. This may be accomplished by using a distance function given above, for example. Once the cluster assignments in block 420 are finished, the clusters' centroids are recalculated in block 430 and 440. In block 430, it is determined if a centroid has been computed for each cluster. If yes, the flow proceeds to block 450. If not, flow proceeds to block 440, where a new cluster centroid is calculated for a certain cluster.

Thus, for each cluster a new cluster centroid is calculated in block 440. The cluster centroid may be calculated in two parts. First, a descriptor centroid in the descriptor space is calculated for the cluster, for example by averaging the descriptors. Then a label centroid is calculated for the cluster by finding the average semantic label for all of the labels. This may be achieved through a regularized label averaging.

Once it is determined in block 430 that all of the cluster centroids have been calculated, in block 450 it is determined if another iteration of centroid calculations should be performed for the clusters. In some embodiments, if a fixed number (e.g., 10, 15, 30, 100) of iterations have not yet been performed, then the determination is made to perform another iteration of centroid calculations. In some embodiments, the determination is based on the results of an overall error function that is tracked and checked to ensure significant error improvements are still being made in the centroid calculations, and in some embodiments, the determination is made based on whether or not the error falls below a specific threshold. Additionally, multiple criteria for termination of centroid calculation may be used. If it is determined that another iteration of centroid calculation should be performed, then flow returns to block 420, where the descriptors are again mapped to the newly computed centroids. Otherwise, the method ends.

Often times, for large data sets with many clusters, k-means computation can be computationally expensive. Thus, some embodiments may use a hierarchical k-means approach or some other clustering method. Also, some embodiments use clustering techniques, such as affinity propagation, that use a sample (e.g., descriptor and/or its associated labels) as the centroid for a cluster instead of using the averaged samples in the cluster. Such methods need to compute a distance between two samples (e.g., para. [0031]), instead of a distance between a sample and a centroid obtained by averaging multiple samples. This avoids the difficulty of computing the semantic average.

Also, in some embodiments, the clusters are delineated using other techniques in alternative to, or in addition to, calculating a distance from only one centroid. For example, a cluster may be delineated by a multi-variable function (e.g., boundary threshold >f(x, y, z)), a cluster may include multiple centroids, and/or one or more distances from one or more of the several centroids may delineate the cluster.

Once the clusters of descriptors in augmented space 120 are generated, the clusters may significantly overlap when considered in the original descriptor space (as shown in FIG. 2 and FIG. 3). In these cases, it may be advantageous to resolve the overlap. For example, to resolve the overlap, if the clusters are close in the descriptor space and are also close in the label space, they probably can be merged. If the clusters are close in the descriptor space but distant in the label space, then a determination must be made whether a merger of the two clusters would retain more knowledge of the labels or whether splitting the clusters would retain more knowledge. This determination may be accomplished using systems and methods described in WO/2012/054399 by Bradley Denney and Anoop Korattikara-Balan and in WO/2012/054352 by Bradley Denney and Anoop Korattikara-Balan, which are incorporated by reference.

For embodiments described above that do not explicitly construct the augmented space, but rather created a composite distance function, the descriptor space centroids may be used for cluster analysis and agglomeration, since the augmented cluster centroids are already made up of descriptor centroids and label centroids. Also, in embodiments where the augmented space was created through a mapping of the descriptors, the mapped descriptor clusters may be used for the cluster analysis and agglomeration.

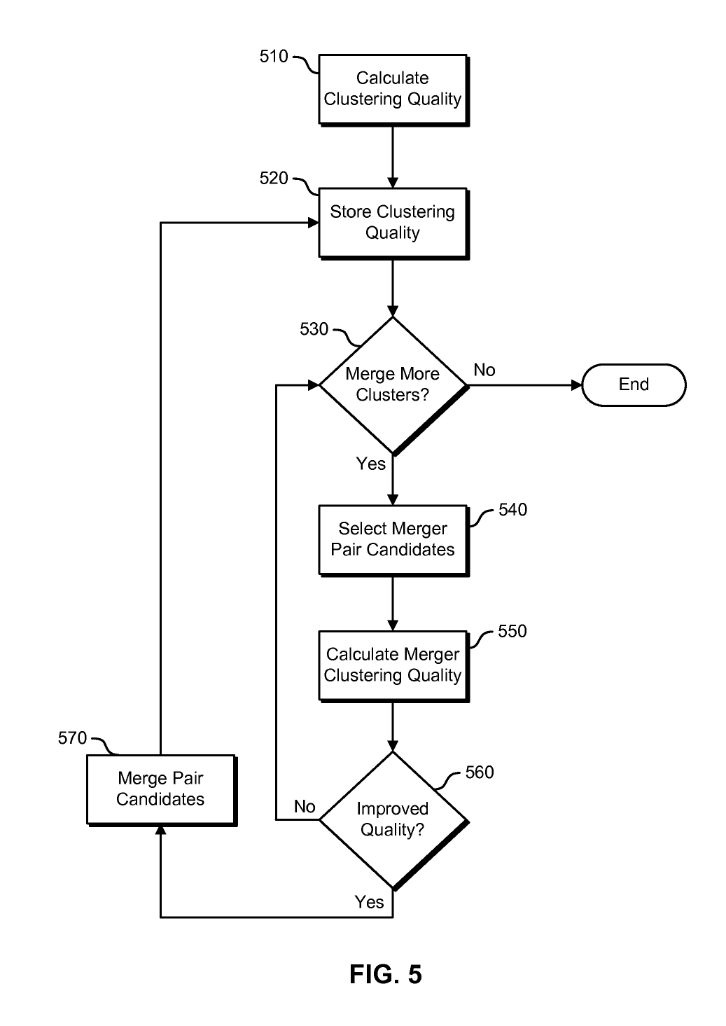

Thus, cluster analysis and agglomeration may be performed to resolve cluster overlap. FIG. 5 illustrates an example embodiment of a method for cluster agglomeration. The method considers merging a pair of clusters using a clustering quality measure. Initially, in block 510 a clustering quality score is calculated based on the initial clustering. In some embodiments, the initial clustering is the clustering determined previously in the augmented space. In embodiments where the augmented space is not explicitly created, the clustering may be based on the cluster centroids as defined in the descriptor space only. In these cases, if cluster centroids co-occur at the exact same location, then the clusters may be considered to be a single cluster. Additionally, in some embodiments additional k-means clustering iterations can be performed using the given descriptor space centroids as the cluster initialization.

Once the initial clustering quality is determined, it is stored in block 520. The flow then proceeds to initiate a loop, whose control is shown in block 530. This loop looks for nearby cluster centroids and presents pairs of centroids for analysis. In one embodiment, the pairs of centroids are chosen based on their proximity in the descriptor space. If more merging is to be performed, then flow proceeds to block 540.

In block 540, a pair of cluster centroid merger pair candidates is selected and merged. The merger of the two centroids can be accomplished in many ways. In some embodiments, one way is to average the two descriptors that are used as centroids, another is averaging all of the descriptors that belong to the two clusters that correspond to the centroids, and another is performing k-means iterations on all of the descriptors and clusters given the assignments to the merged clusters and other non-merged clusters. Also, some embodiments simply assign the two existing clusters to the same cluster label, thereby representing the cluster with multiple cluster centers.

Next, in block 550, the merger clustering quality is calculated, and, in block 560 a determination is made as to whether the merger improves clustering quality based on the stored clustering quality and the merger clustering quality. If a determination is made that the clustering quality would be improved via a merger, then the merger is finalized in block 570 and the clusters associated with the pair of candidates are merged. The new clustering quality score is then stored in block 520. If, on the other hand, a determination is made that clustering quality is better without the merger, then flow returns to block 530, where it is determined whether more pairs should be considered for merger. If in block 530 a determination is made that no more pairs should be considered, then the flow terminates.

In some embodiments, the method shown in FIG. 5 is modified to take advantage of a distributed computing environment. In these embodiments, multiple candidate merger pairs are selected and analyzed in parallel. In this case, the candidates selected may be sufficiently far apart so that the effect of any merger of one cluster pair will not have a major impact on the decision to merge a second pair. In other words, the parallelized pair candidates should be chosen such that the parallel analysis of the respective effects of their mergers will result in a similar result that would have been obtained had the mergers been done in a serial manner (e.g., as described in FIG. 5).

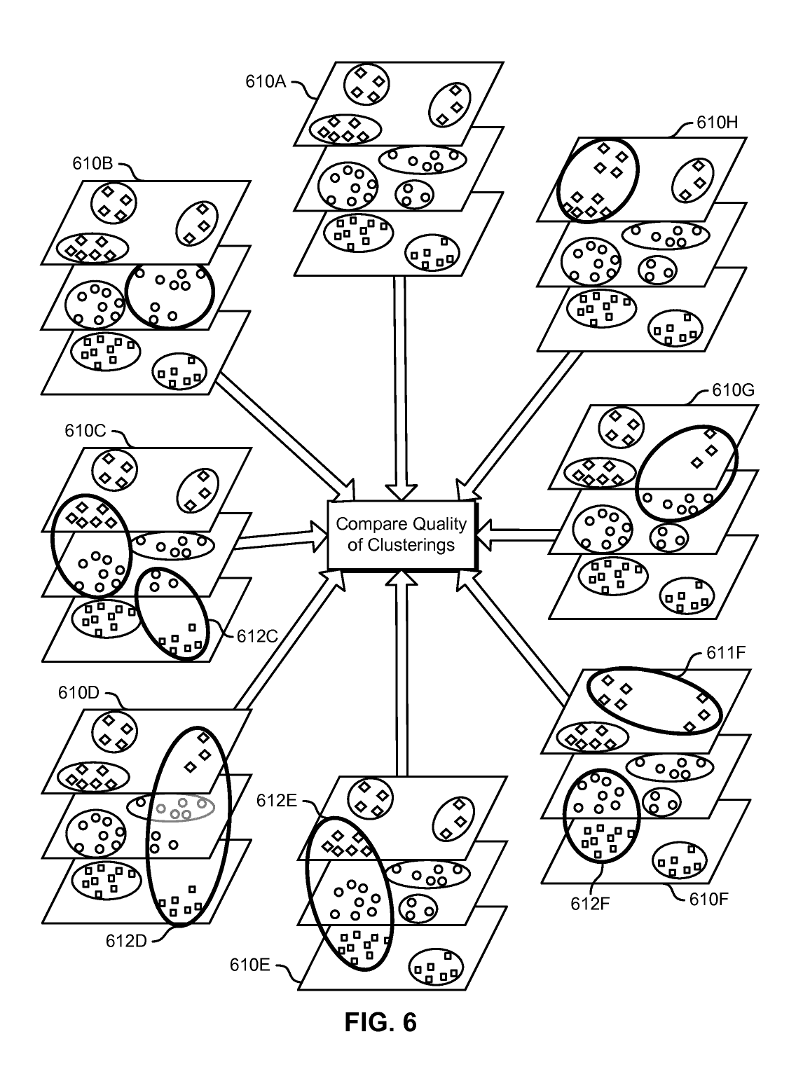

FIG. 6 illustrates example embodiments of agglomerated clusters. First, the descriptors are clustered to form the initial set of clusters 610A. Next, the clusters are agglomerated. Sets of Clusters 610B, 610H, and 610G each show a respective candidate pair of clusters that are agglomerated, and the respective quality of the clustering for the sets of clusters 610B, 610H, and 610G is analyzed after the candidate pair is agglomerated. Sets of clusters 610C and 610F each show two candidate pairs that are agglomerated. The quality check for a set of clusters may be performed serially for the candidate pairs (e.g., one candidate pair 611F is agglomerated and the quality of set 610F is checked, then the other candidate pair 612F is agglomerated and the quality of set 610F, which now includes two agglomerated candidate pairs 611F and 612F, is checked) or in parallel for the candidate pairs (e.g., both candidate pairs 611F and 612F are agglomerated, and the quality of set 610F is check when set 610F includes both agglomerated candidate pairs 611F and 612F). Also, in some embodiments, the initial set of clusters includes clusters that span multiple planes in the augmented space (e.g., set 612C, 610E, 610G).

Also, agglomerated candidate pairs can be further agglomerated. For example, if candidate pair 612C is agglomerated to form cluster 612C, then cluster 612C can be used to form candidate pair 612D. Also, if candidate pair 612F is agglomerated to form cluster 612F, then cluster 612F can be used to form candidate pair 612E. Thus, a candidate pair may include two or more of the clusters in the initial set of clusters 610A, and the quality evaluation of the different candidate pairs can consider the quality of the clustering when two or more of the clusters in the initial set of clusters 610A are agglomerated.

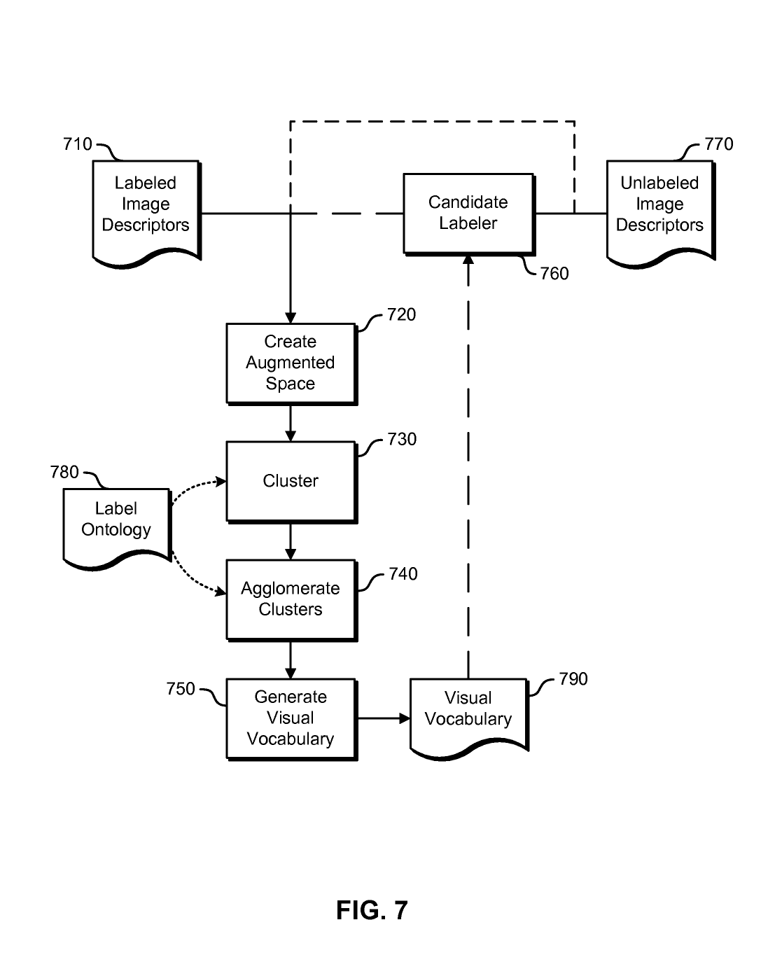

FIG. 7 illustrates an example embodiment of a method for generating a visual vocabulary. A visual vocabulary associates a given visual descriptor with a visual word, for example by mapping a descriptor to a visual word (e.g., a cluster that contains similar descriptors), thereby creating a way to describe descriptors more generally and/or succinctly (e.g., if a descriptor belongs to the k-th cluster then the descriptor may be encoded with the visual word k, which allows for an n-dimensional descriptor to be represented with the visual word k rather than the n-dimensional information in the descriptor). In this way, visual words describe visually similar patches in an image. This is analogous to real words, like the word “red,” which can be used to represent many similar looking colors (many “shades of red”). Thus, a visual word may be used to represent similar colors more succinctly than representing each of the colors with its respective RGB values.

In FIG. 7, the flow begins with a set of labeled image descriptors 710. Also, in some embodiments unlabeled image descriptors 770 are also used. In block 720 an augmented space is constructed. Next, flow proceeds to block 730, descriptors are clustered. In block 740, clusters are agglomerated, for example nearby descriptor clusters are combined if the combination of the clusters improves a cluster quality score given a set of assumed truth labels. Also, a label ontology 780 may be used during the clustering in block 730 and/or the agglomeration of the clusters in block 740. In block 750, the clusters are used to construct a visual vocabulary 790, which may be used to label unlabeled images.

Optionally, the method in FIG. 7 can apply a feedback loop that allows unlabeled images to be labeled to generate a set of likely labels on a set of unlabeled image descriptors, which are then used to construct a new vocabulary. In such embodiments, the system starts with the labeled image descriptors 710 and constructs a visual vocabulary 790. Then the unlabeled image descriptors 770 are labeled with a label candidate in block 760. The probability of a label applying to an image and the image's associated descriptors can be estimated given the relative frequency of the occurrence of the label in the visual vocabulary 790. If it is determined that the probability estimate exceeds a pre-determined threshold, then the label is assigned to the unlabeled image descriptors 770 of the image as a candidate label. Then the entire procedure is repeated using all labeled image descriptors 710 and all unlabeled image descriptors 770 with their associated candidate labels. The resulting visual vocabulary 790 is again used to re-estimate candidate labels (block 760) for the unlabeled image descriptors 770. This iteration can be performed for a fixed number of iterations or until the candidate label assignments for the unlabeled image descriptors 770 do not change. In some embodiments, even the unlabeled image descriptors 770 that are not assigned candidate labels may be used in the iterative process.

Also, though the labels of the labeled image descriptors 710 may not be modified, additional labels may be added to the labeled image descriptors 710 if the probability of a label applying to a respective labeled image descriptor is estimated to be high enough. Thus, based on the new set of labeled descriptors, the augmented clustering and agglomeration steps may be repeated. The results of this new iteration can again be used to improve the labels of the training data (e.g., the labeled image descriptors 710).

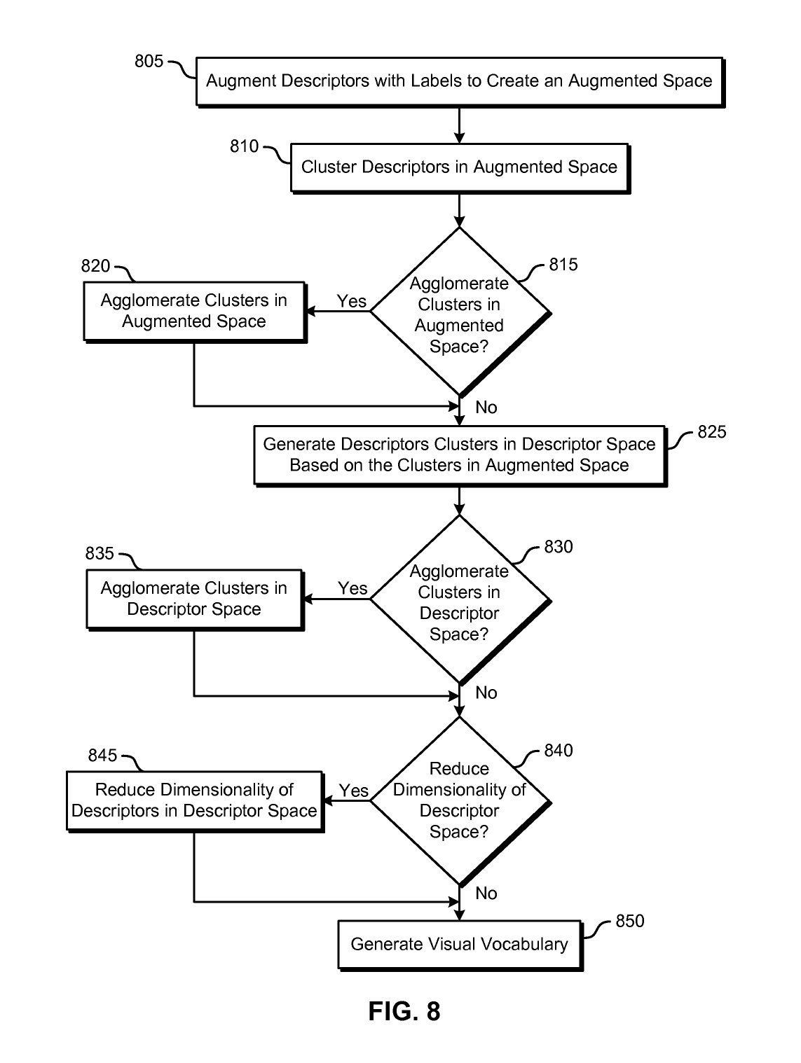

FIG. 8 illustrates an example embodiment of a method for generating a visual vocabulary. Flow starts in block 805, where descriptors are augmented with labels to create an augmented space. In some embodiments, the augmented space is explicitly constructed, and in others the augmented space is not explicitly constructed. Next, in block 810, the descriptors in the augmented space are clustered (see, e.g., the method of FIG. 4). Flow proceeds to block 815, where it is determined if the clusters of descriptors in augmented space will be agglomerated. If not, flow proceeds to block 825. If yes, flow proceeds to block 820, where the clusters of descriptors in augmented space are agglomerated (see, e.g., the method of FIG. 5), and then flow proceeds to block 825. Note that some embodiments agglomerate descriptors in augmented space to form a visual vocabulary, and some do not. Also, in some embodiments, in blocks 820 and 835 clusters are divided to form more clusters in addition to or in instead of agglomerating the clusters. For example, a cluster may be divided if the division produces a higher cluster quality score.

In block 825, descriptor clusters are generated in descriptor space based on the clusters in augmented space. Next, in block 830, it is determined if the clusters in descriptor space will be agglomerated. If not, flow proceeds to block 840. If yes, flow proceeds to block 835, where the clusters of descriptors in descriptor space are agglomerated (see, e.g., the method of FIG. 5), then flow proceeds to block 840. In block 840, it is determined if the dimensionality of the descriptor space will be reduced. If not, flow proceeds to block 850. If yes, flow proceeds to block 845, where the dimensionality of the descriptors in the descriptor space is reduced. Finally, in block 850, a visual vocabulary is generated based on the descriptors in descriptor space.

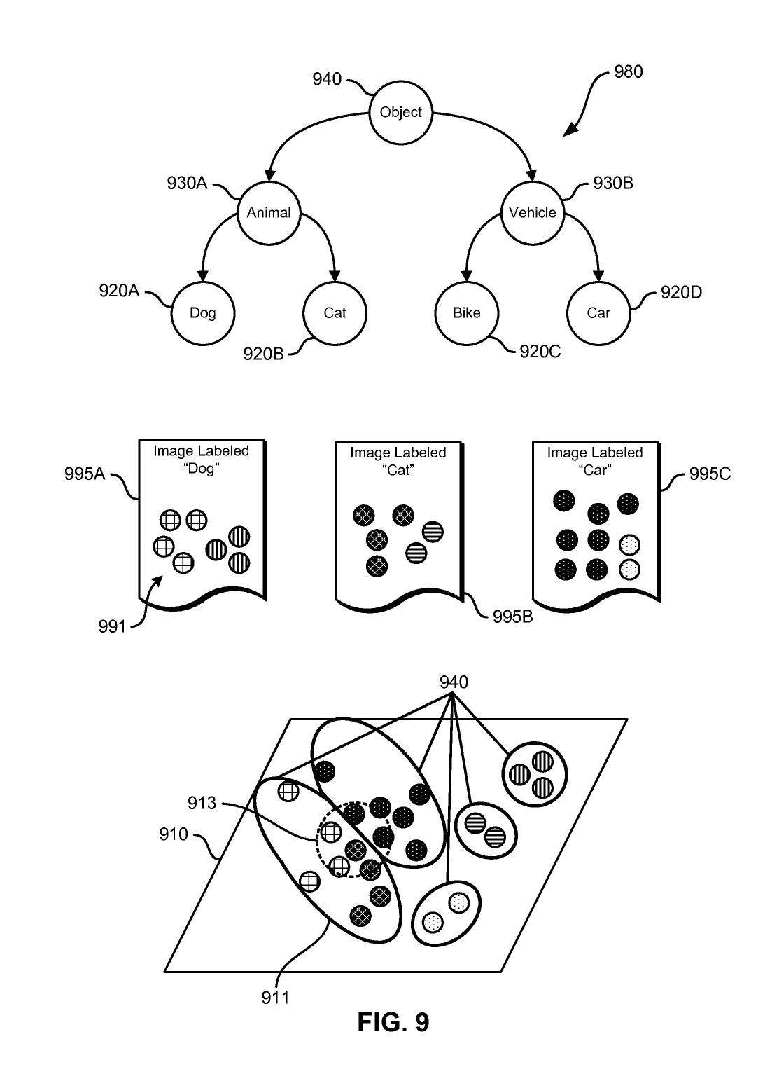

FIG. 9 illustrates an example embodiment of visual words that are generated based on descriptors that are clustered based on labels. In FIG. 9, an ontology 980 defines relationships among, inter alia, the labels dog 920A, cat 920B, and car 920D. Also, an image 995A is labeled “dog”, and image 995B is labeled “cat”, and an image 995C is labeled “car”. The descriptors in the images 995A-C are identified (the descriptors in image 995A are identified as descriptors 991) and associated with the labels of their respective images. A descriptor space 910 shows the visual relationship of the descriptors. The descriptors space 910 shows two dimensions, but other descriptor spaces may have more or less dimensions.

Though some of the descriptors labeled “dog” are visually closer to some of the descriptors labeled “car” than to some of the other descriptors labeled “dog” and/or “cat”, the descriptors labeled “dog” are not clustered with the descriptors labeled “car” and vice versa because the distance between “dog” and “car” in the semantic dimension, which is defined by the ontology 980, effectively exceeds a threshold (e.g., the effective threshold comes from a penalty for forming clusters with distant object members). For example, the descriptors (which include descriptors labeled “dog”, “cat”, and “car”) in the space 913 are visually similar, but they are not all clustered together. However, some descriptors labeled “dog” are close enough to some of the descriptors labeled “cat” in both the visual and semantic dimensions to pass an effective threshold, and thus may be clustered together, for example cluster 911. Moreover, some of the descriptors in cluster 911 are not as visually similar to the other descriptors (labeled “dog” or “cat”) in cluster 911 as they are to descriptors labeled “car” in space 913, but they are nevertheless clustered with the other descriptors in cluster 911. Accordingly, the shapes (i.e. the cluster boundaries) of the clusters in the descriptor space 910 may be defined to exclude descriptors that are too far away when one or more semantic dimensions are considered. Furthermore, the shapes of the clusters in the descriptor space 910 may be used to define visual words 940 (e.g., the shape of cluster 911 may define a corresponding visual word).

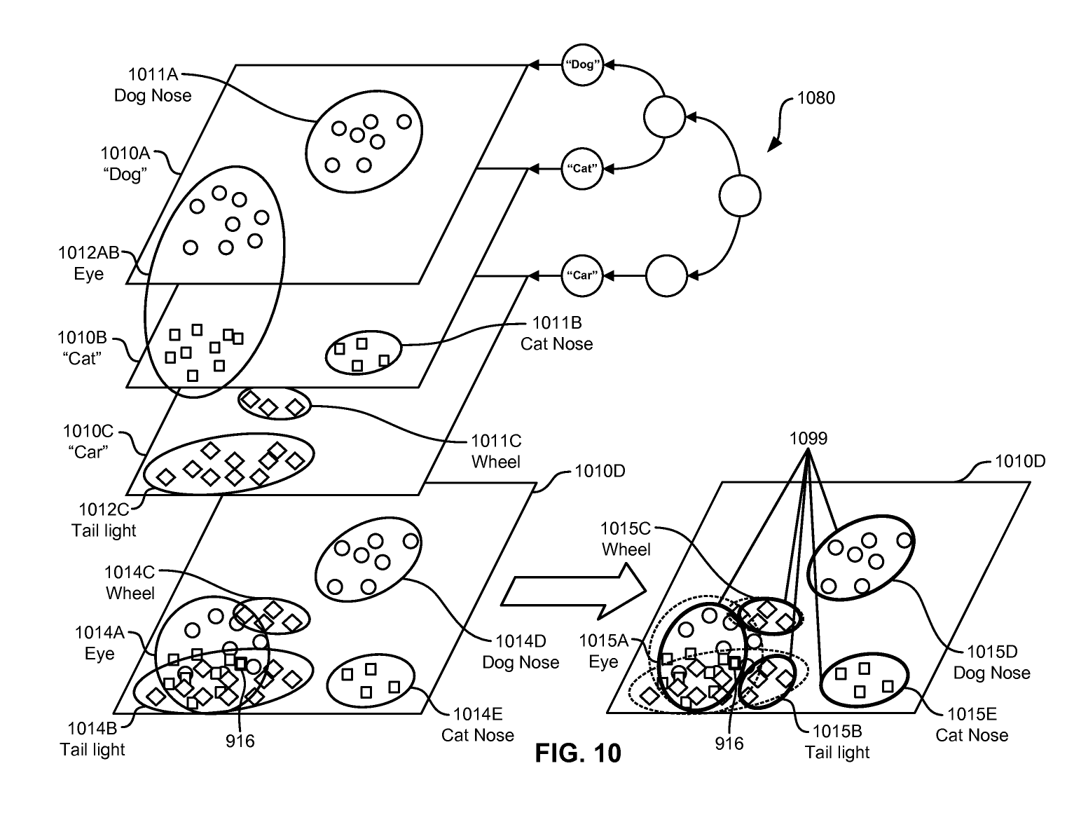

FIG. 10 illustrates an example embodiment of visual words that are generated based on descriptors that are clustered based on labels. FIG. 10 shows an ontology 1080 that includes, inter alia, the labels “dog”, “cat”, and “car”, along with associated planes 1010A-C in augmented space. The descriptors are clustered based both on visual similarity and semantic similarity. To illustrate the semantic and visual similarity, the physical features associated with the descriptors are also shown. Thus, the descriptors in cluster 1011A are associated with a dog nose, the descriptors in cluster 1011B are associated with a cat nose, the descriptors in cluster 1011C are associated with a wheel, the descriptors in cluster 1012AB are associated with an eye, and the descriptors in cluster 1012C are associated with a tail light.

The projection of the descriptors into descriptor space 1010D is also shown. In this embodiment, the eye cluster 1014A partially overlaps the wheel cluster 1014C and the tail light cluster 1014B (the dog nose cluster 1014D and the cat nose cluster 1014E do not overlap with other clusters). This may indicate that the descriptors for an eye are visually similar to the descriptors for a wheel and a tail light. Therefore, for example, clustering based only on visual similarity may generate clusters and visual words that do not effectively distinguish between an eye and either a wheel or a tail light. However, if the descriptors are clustered in descriptor space based on the clusters in the augmented space, the semantic information and ontology can be used to generate clusters and visual words 1099 that more effectively discriminate between an eye, a wheel, and a tail light. Thus, using semantic dimensions, it is possible to generate an eye cluster 1015A, a wheel cluster 1015C, and a tail light cluster 1015B that all do not overlap one another (in this embodiment, there is no change to the dog nose cluster 1015D and the cat nose cluster 1015E). Therefore, using the more discriminative visual words, a descriptor can be more confidently associated with a visual word. For example, using clusters 1014A and 1014B, a first descriptor 916 that is associated with an eye would map to both cluster 1014A and cluster 1014B, and thus could be described by the respective visual words associated with both cluster 1014A (“eye”) and cluster 1014B (“tail light”). Accordingly, the visual word for “eye” may not effectively discriminate from the visual word for “tail light”. However, using clusters 1015A and 1015B, the first descriptor would map to cluster 1015A and not cluster 1015B. Thus, the first descriptor could more confidently be described with the visual word associated with cluster 1015A (“eye”) than the respective visual words associated with cluster 1014A or cluster 1014B.

Once the clusters 1015A-E have been generated, they can be used as visual words that describe and/or encode descriptors. For example, a descriptor can be mapped to the descriptor space 1010D, then the cluster that the descriptor is mapped to can be determined. The cluster can then be used to describe and/or encode the descriptor. Therefore, if a descriptor is mapped to cluster 1015D, a visual word describing “dog nose” (a cluster that contains visually similar descriptors that are associated with a dog nose) for example, the descriptor can summarily be described by “dog nose.” Note that the descriptors and/or clusters may not actually be associated with a semantic word (e.g., “dog nose”). Though the visual words are formed in regions of semantic concepts like “dog” and “car,” the labels “dog nose” and “tail light” are used to illustrate the idea of capturing these concepts through clustering in the augmented space. Additionally, if a vector contains binary entries for each cluster in the descriptor space, where a “1” indicates that a descriptor is mapped to the respective cluster and 0 indicates that the descriptor does not map to the respective cluster, the descriptor can be indicated by a “1” in the entry associated with “dog nose.” Thus, if a vector contains five entries ([ ],[ ],[ ],[ ],[ ]), where the first is associated with cluster 1015A, the second with cluster 1015B, the third with cluster 1015C, the fourth with cluster 1015D, and the fifth with cluster 1015E, a descriptor that is mapped to cluster 1015B may be encoded as [0],[1],[0],[0],[0]. Similarly, a descriptor that is mapped to cluster 1015A may be encoded as [1],[0],[0],[0],[0]. Therefore, a high-dimensional descriptor can be described in a more simple form. In some embodiments, soft assignments to the clusters in the descriptor space can be determined, so that the cluster may be encoded as [0.7],[0.3],[0],[0],[0], for example.

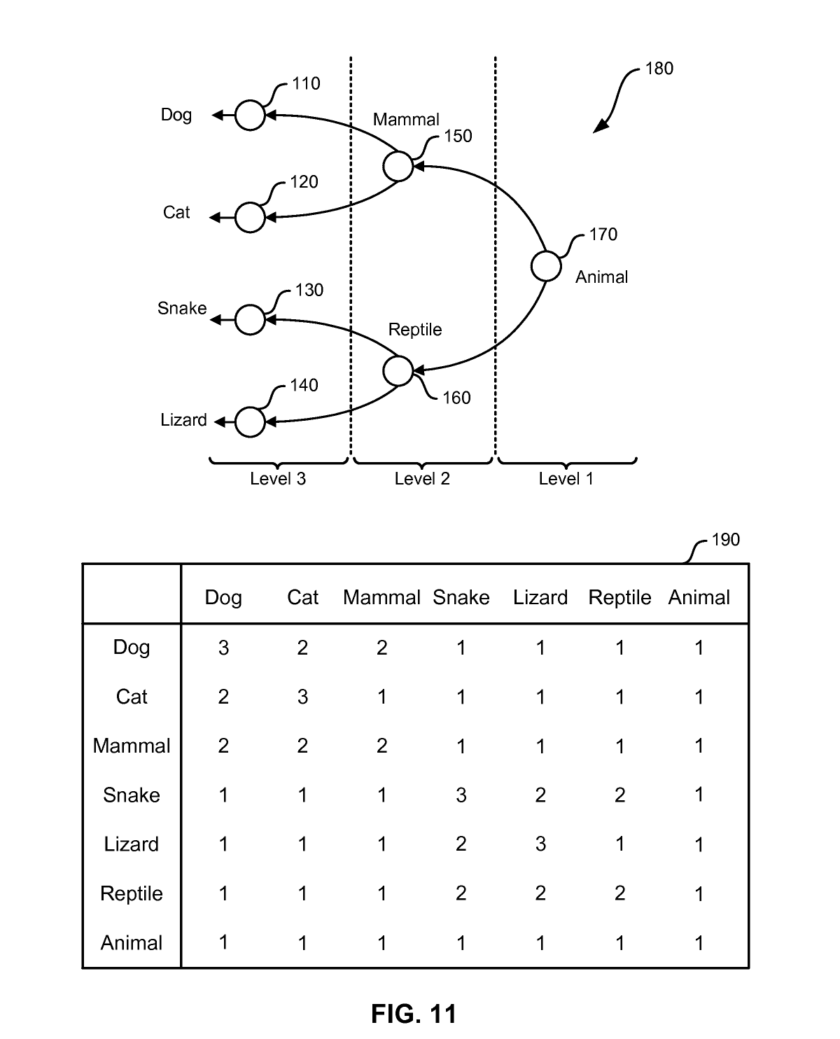

Also, semantic concepts are often not necessarily mutually exclusive or disjoint. Therefore, given a set instances of semantic concepts, it can be useful to average the set and obtain a meaningful mean that describes the set. FIG. 11 illustrates an example embodiment of an ontology 1180 and a similarity table 1190. Also, though semantic averaging is described, the systems and methods described herein are not limited to semantic data, and they may be applicable to any data set that contains a graph-like relationship. This includes tree-like relationships often found in taxonomies and other ontologies.

The ontology 1180 describes the relationship between different semantic labels and concepts and includes the animal label 1170, which is divided into a mammal label 1150 and a reptile label 1160. The mammal label 1150 is divided into a dog label 1110 and a cat label 1120, while the reptile label 1160 is divided into a snake label 1130 and a lizard label 1140. In some embodiments, semantic ontologies can be represented with large trees containing hundreds, thousands, and tens of thousands of nodes.

Different methods can be used to average the semantic labels. In some embodiments, semantic labels are considered to be a vector space by treating the labels as sparse binary vectors where each dimension corresponds to a different semantic label. As an example, a distance between labels can be defined for sparse binary label vectors lᵢ and lⱼ, as

ρ_{S}²(lᵢ,lⱼ)=lᵢ^{T}Slᵢ+lⱼ^{T}Slⱼ−2lᵢ^{T}Slⱼ,

where S is a similarity matrix defining the semantic similarity between various concepts. The matrix S may be a symmetric matrix. If the matrix is symmetric (or at least Hermitian) and positive definite, then an inner-product of two label vectors x and y can be defined as

[symbol]

x,y [symbol] =x^{T}Sy.

The inner-product induced metric given above can then be derived from this inner-product.

Finding an average label to be computed from a collection of label vectors may be equivalent to finding the label vector y which minimizes

$${min}_{y} {\sum }_{i} {ρ}_{S}^{2} ( {l}_{i} , y ) = {min}_{y} {\sum }_{i} {l}_{i}^{T} S {l}_{i} + {y}^{T} S y - 2 {l}_{i}^{T} S y {}^{yields} {min}_{y} {y}^{T} S y - 2 {\overline{l}}^{T} S y ,$$

the minimizer of which is

$$y = \overline{l} = \frac{1}{N} {\sum }_{i = 1}^{N} {l}_{i} ,$$

which is the mean of the assigned labels themselves. This result may be unsatisfying, because the semantic average of two concepts should in many cases merge the concepts into one higher level concept. Thus, another embodiment adds a regularization term on the semantic label vector to give an incentive to choose a more sparse solution for the mean label vector y, and

$${min}_{y} {\sum }_{i} {ρ}_{S}^{2} ( {l}_{i} , y ) + λ {‖ y ‖}_{P} ,$$

where λ is a regularization parameter chosen to achieve the desired effect, and where the norm ∥y∥ₚ is ideally chosen as ∥y∥₀, although in practice it is usually solved as ∥y∥₁ or sometimes ∥y∥₂ in order to simplify the solution. By choosing a large enough regularization parameter, the simplicity of the conceptual label average can be controlled. The parameter λ may be predetermined or may be experimentally determined such that a clustering quality score is optimized. In addition, in some embodiments, a final threshold to the concept label vector may be used to eliminate weakly labeled classes.

For the p=2 embodiment the expression can be explicitly solved according to

$$y = {( S + λ I )}^{- 1} S \frac{1}{N} {\sum }_{i = 1}^{N} {l}_{i} , \qquad ( 1 )$$

which is also referred to herein as “equation (1)”.

Since the matrix S is assumed to be positive definite then S+λI is positive definite for non-negative λ. This can be demonstrated by considering a non-zero vector z, then

z^{T}(S+λI)z=z^{T}Sz+λz^{T}Z,

and, since S is positive definite (e.g., z^{T}Sz >0 for all non-zero vectors z) and the regularization parameter λ is always non-negative,

z^{T}(S+λI)z=z^{T}Sz+λz^{T}z>0.

Thus, since S+λI is positive definite, it is also invertible for all λ>0. And therefore a solution for the embodiment is given by equation (1) in this case.

In one embodiment, the similarity between two nodes in the hierarchy is given by the depth of their most common ancestor. Therefore, a dog 1110 and a cat 1120 have a most common ancestor of mammal 1150. If the depth of the leaves (dog, cat, snake, and lizard) is measured as 3, the depth of the middle nodes (mammals and reptiles) as 2, and the depth of the animal node as 1, then the similarity table 1190 can be generated. The similarity table 1190 shows the depth of the closest common node for two labels. For example, the closest common node (e.g., ancestor node) for dog and cat, which is mammal, has a depth of 2. Also for example, the closest common node for cat and lizard, which is animal, has a depth of 1.

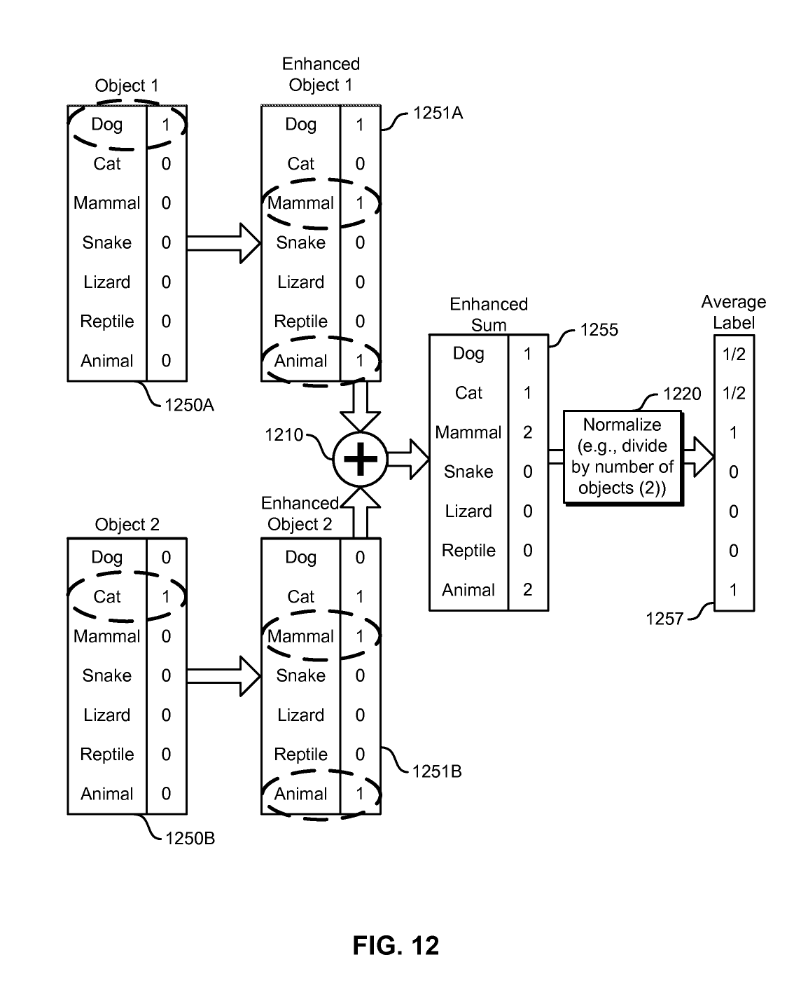

The ontology 1180, which defines a taxonomy, can be used to complete the hierarchical labels for both dog and cat, to sum the labels, and to divide the sum of the labels by the number of objects. This is illustrated in FIG. 12, which illustrates an embodiment of a method for generating a semantic average for two or more labels. Take the specific example where two objects that are semantically labeled “dog” and “cat” are provided. In FIG. 12, the two label vectors for object 1 (vector 1250A) and object 2 (vector 1250B) are “dog” and “cat”, respectively. Using the defined taxonomy in the ontology 1180, the label vectors are enhanced with the parent labels of “dog” and “cat” so that the enhanced label vector for dog 1251A and the enhanced label vector for “cat” 1251B also include the labels “mammal” and “animal”. The enhanced label vectors 1251A-B are added together in block 1210 to generate an enhanced sum vector 1255. The enhanced sum vector 1255 is normalized in block 1220 to create an average vector 1257. In the embodiment shown, the normalization is performed by dividing the values in the vector by the number of objects (2). The average vector 1257 is used to represent the mean label vector T.

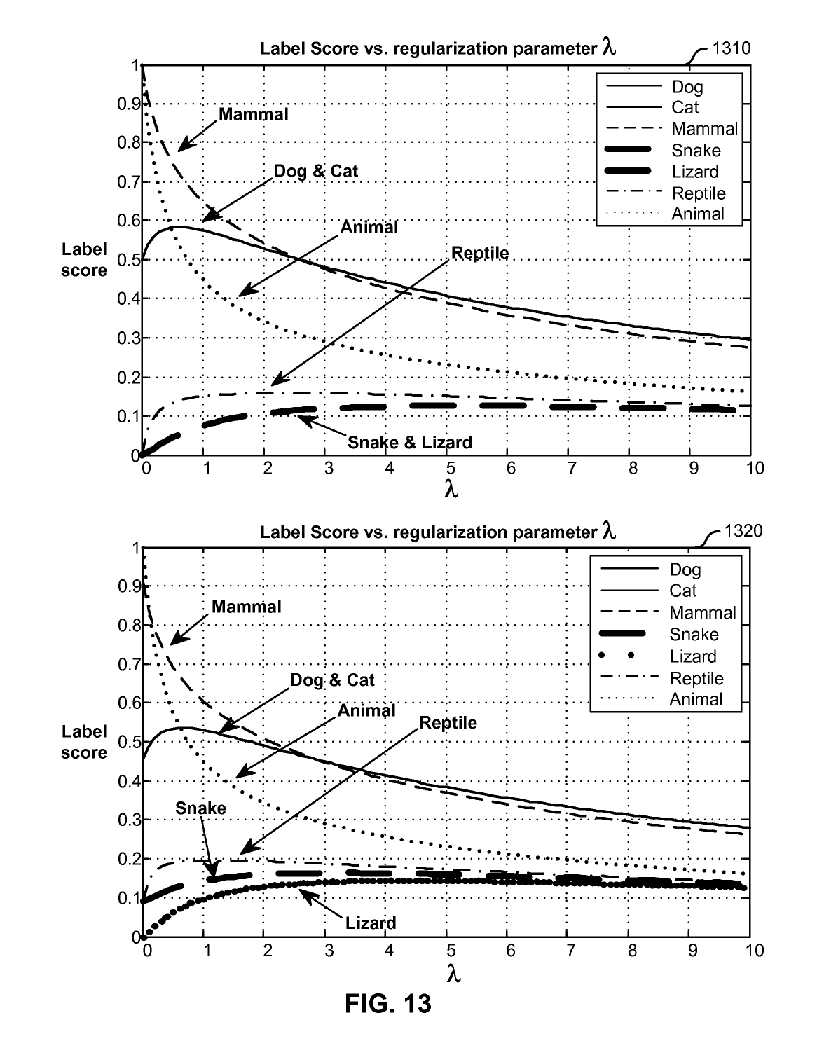

Using the average vector 1257 (where animal=1, mammal=1, dog=½, and cat=½) and an embodiment of the semantic averaging method that uses the L₂ regularized label scores, the results shown in the first graph 1310 in FIG. 13 are obtained for various values of the regularization parameter λ. The first graph 1310 shows that with no regularization (i.e., λ=0) the average label is the score for the labels. This gives an equal weight of 1 to mammal and animal, equal weight of ½ to dog and cat, and zero weight to other labels. But as λ is increased, the weight of the animal label and the mammal label begin to drop. The weight of the animal label drops more quickly than the weight of the mammal label. The mammal label is the highest weighted label up to λ=approx. 2.5, after which its weight is very similar to the weights of the dog and cat labels.

In second graph 1320, an example is considered with 11 objects. 5 objects are dogs, 5 objects are cats, and 1 object is a snake. The second graph 1320 shows a similar result to the first graph 1310 with the exception that the reptile and snake scores are increased and the non-regularized solution prefers the animal label over the mammal label by assigning it a higher score. However, with increased λ, the mammal score quickly becomes the preferred label. Furthermore, for L₁ regularization, some methods exist to handle the discontinuity in the derivative of the L₁ norm. In some embodiments, a brute force search across all single label representations can provide the label that best embodies a set of labels. The best single label which embodies the set of labels could be the label that, for example, minimizes the squared distances to the labels in the set. Also, some embodiments represent an averaged label with a virtual label, which may include a cluster of real labels. For the sake of simplicity, let Lᵢ denote a label (e.g., Lᵢ=dog or cat). Assume that a cluster contains K labels, {L₁, . . . , L_{K}}, where the label Lᵢ occurs Nᵢ times in the cluster. To represent the average label of the cluster, a virtual label

L̅={p₁, . . . ,p_{K}}

is generated, and the conditional probability of a label may be evaluated according to

$${p}_{i} = p ( {L}_{i} \vert \overline{L} ) = \frac{{N}_{i}}{{\sum }_{j = 1}^{K} {N}_{j}} .$$

A distance from a real label, L, to the virtual label, L̅, may be computed according to

$$d ( L , \overline{L} ) = {\sum }_{i = 1}^{K} {p}_{i} \cdot d ( L , {L}_{i} ) ,$$

where d(L, Lᵢ) is a general semantic dissimilarity measure between two real labels, L and Lᵢ. In one embodiment, a k-means like algorithm is used to semantically cluster the virtual labels defined above. First, the algorithm picks k distinct labels as initial cluster centroids. In some embodiments, the initial centroids are randomly chosen, and in some embodiments the initial centroids are chosen such that they cover the label space more completely, similar to a k-means++ algorithm. Also, in some embodiments the initial centroid virtual label weights are initialized so that pⱼ is set to 1 when j coincides with the label index of the chosen centroid (Lⱼ=the label chosen as the centroid). All other weights pᵢ, i≠j are set to zero.

Next, the following two operations are then performed at least once: 1) the mapping of all labels to the nearest centroid, and 2) the recalculating of the virtual label centroids. The first operation in the iteration is done by measuring the distance from the label to the virtual label, for example as described above. The second operation is accomplished by calculating L̅ based on the mapped cluster members, for example as described above.

The ability to average semantic labels with defined relationships enables the clustering of semantic labels with concept generalizing capabilities. For example, in one embodiment, the clustering of semantic labels is performed using k-means clustering. In this algorithm, there is an initialization phase where initial cluster centroids are selected. The initial centroids may be k randomly selected cluster centroids and/or may be selected from the label vectors of the set of objects to be clustered. In some embodiments, a single label vector from the hierarchy is selected and then modified to contain one of its most specific (deepest) descendants, if any exist. If no descendants exist, then the initially selected label itself is used as the cluster centroid. Then the following two operations are repeated: 1) all objects are mapped to their nearest cluster centroids using the distance, and 2) each centroid is recalculated using the cluster members by finding the highest scoring label from the regularized label scoring method described above. In some embodiments the above steps are repeated a fixed number of times. In other embodiments, the steps are terminated after convergence is sufficiently obtained.

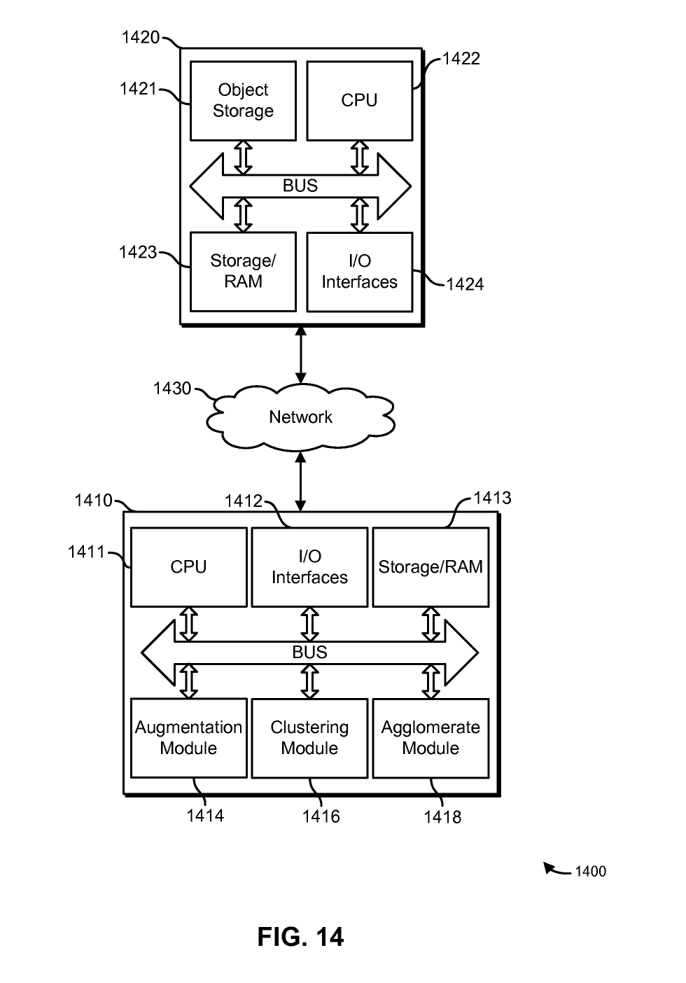

FIG. 14 is a block diagram that illustrates an example embodiment of a system 1400 for generating a visual vocabulary. The system includes a vocabulary generation device 1410 and an object storage device 1420, both of which include one or more computing devices (e.g., a desktop computer, a server, a PDA, a laptop, a tablet, a phone). The vocabulary generation device 1410 includes one or more processors (CPU) 1411, I/O interfaces 1412, and storage/RAM 1413. The CPU 1411 includes one or more central processing units (e.g., microprocessors) and is configured to read and perform computer-executable instructions, such as instructions stored in the modules. The computer-executable instructions may include those for the performance of the methods described herein. The I/O interfaces 1412 provide communication interfaces to input and output devices, which may include a keyboard, a display, a mouse, a printing device, a touch screen, a light pen, an optical storage device, a scanner, a microphone, a camera, a drive, and a network (either wired or wireless).

Storage/RAM 1413 includes one or more computer readable and/or writable media, and may include, for example, a magnetic disk (e.g., a floppy disk, a hard disk), an optical disc (e.g., a CD, a DVD, a Blu-ray), a magneto-optical disk, a magnetic tape, semiconductor memory (e.g., a non-volatile memory card, flash memory, a solid state drive, SRAM, DRAM), an EPROM, an EEPROM, etc. Storage/RAM 1413 may store computer-readable data and/or computer-executable instructions. The components of the vocabulary generation device 1410 communicate via a bus.

The vocabulary generation device 1410 also includes an augmentation module 1414, a clustering module 1416, and an agglomerate module 1418. Modules may include logic, computer-readable data, and/or computer-executable instructions and may be implemented in software (e.g., Assembly, C, C++, C#, Java, BASIC, Perl, Visual Basic), firmware, and/or hardware. In other embodiments, the vocabulary generation device 1410 may include additional or less modules, the modules may be combined into fewer modules, or the modules may be divided into more modules. The augmentation module 1414 includes computer-executable instructions that may be executed by the vocabulary generation device 1410 to cause the vocabulary generation device 1410 to augment one or more descriptors with label information, map the descriptors to an augmented space, and/or preform semantic averaging. The clustering module 1416 includes computer-executable instructions that may be executed to cause the vocabulary generation device 1410 to generate descriptor clusters in descriptor space and/or augmented space, and/or to cluster semantic labels and/or virtual labels. Also, the agglomerate module 1418 includes computer-executable instructions that may be executed to cause the vocabulary generation device 1410 to agglomerate or divide clusters in augmented space and/or descriptor space. Therefore, the augmentation module 1414, the clustering module 1416, and the agglomerate module 1418 may be executed by the vocabulary generation device 1410 to cause the vocabulary generation device 1410 to perform the methods described herein.

The object storage device 1420 includes a CPU 1422, storage/RAM 1423, and I/O interfaces 1424. The object storage device also includes object storage 1421. Object storage 1421 includes a computer-readable medium that stores objects (e.g., descriptors, images, image labels) thereon. The members of the object storage device 1420 communicate via a bus. The vocabulary generation device 1410 may retrieve objects from the object storage 1421 in the object storage device 1420 via a network 1430.

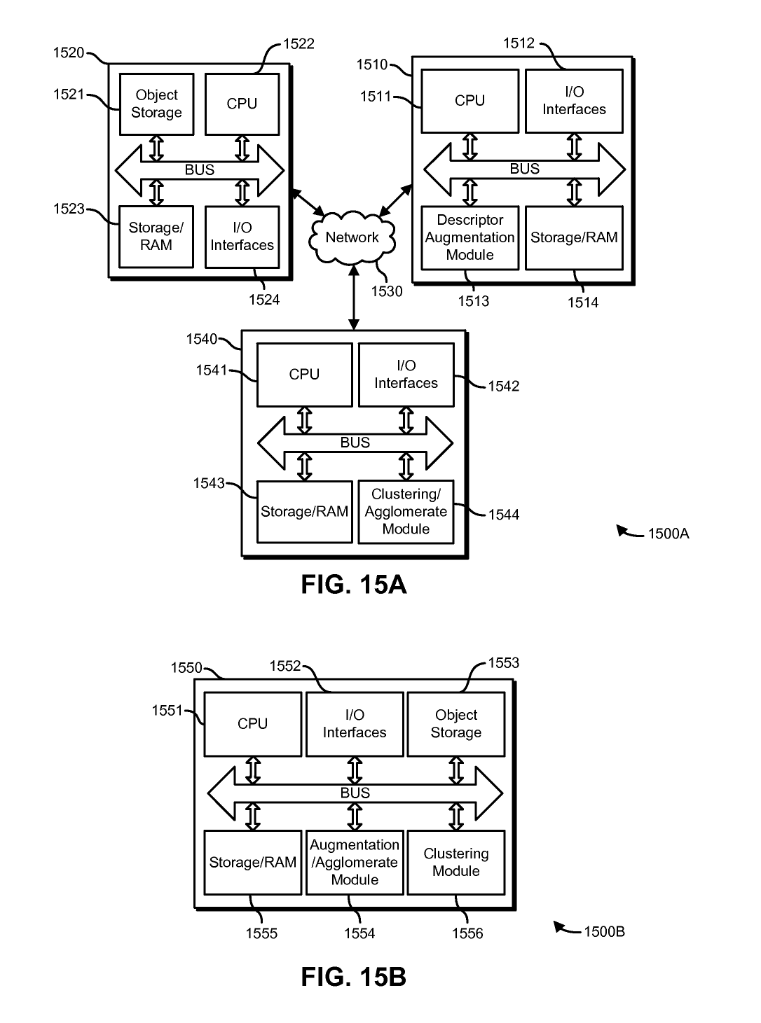

FIG. 15A is a block diagram that illustrates an example embodiment of a system 1500A for generating a visual vocabulary. The system 1500A includes an augmentation device 1510, an object storage device 1520, and a clustering device 1540. The augmentation device 1510 includes a CPU 1511, I/O interfaces 1512, a descriptor augmentation module 1513, and storage/RAM 1514. When executed, the descriptor augmentation module 1513 augments descriptors with labels, generates an augmented space, and/or performs semantic averaging. The object storage device 1520 includes a CPU 1522, I/O interfaces 1524, object storage 1521, and storage/RAM 1523. The clustering device 1540 includes a CPU 1541, I/O interfaces 1542, storage/RAM 1543, and a clustering/agglomerate module 1544. The components of each of the devices communicate via a respective bus. In the embodiment shown in FIG. 15A, the augmentation device 1510 generates augmented descriptors using the descriptor augmentation module 1513 and the clustering device 1540 generates descriptor clusters and agglomerates or divides descriptor clusters using the clustering/agglomerate module 1544. The clustering device 1540, the augmentation device 1510, and the object storage device 1520 communicate via a network 1530 to access the objects in the object storage 1521, the augmented descriptors, and the clusters. Thus, in this embodiment, different devices may store the objects, cluster and agglomerate the objects, and augment the descriptors.

FIG. 15B is a block diagram that illustrates an example embodiment of a system 1500B for generating a visual vocabulary. The system includes a vocabulary generation device 1550 that includes a CPU 1551, I/O interfaces 1552, object storage 1553, an augmentation/agglomerate module 1554, storage/RAM 1555, and a clustering module 1556. The members of the vocabulary generation device 1550 communicate via a bus. Therefore, in the embodiment shown, one computing device stores the objects, clusters descriptors, agglomerates or divides the descriptor clusters, and augments the descriptors. However, other embodiments may organize the components differently than the example embodiments shown in FIG. 14, FIG. 15A, and FIG. 15B.

The above described devices, systems, and methods can be implemented by supplying one or more computer-readable media having stored thereon computer-executable instructions for realizing the above described operations to one or more computing devices that are configured to read the computer-executable instructions and execute them. In this case, the systems and/or devices perform the operations of the above-described embodiments when executing the computer-executable instructions. Also, an operating system on the one or more systems and/or devices may implement the operations of the above described embodiments. Thus, the computer-executable instructions and/or the one or more computer-readable media storing the computer-executable instructions thereon constitute an embodiment.

Any applicable computer-readable medium (e.g., a magnetic disk (including a floppy disk, a hard disk), an optical disc (including a CD, a DVD, a Blu-ray disc), a magneto-optical disk, a magnetic tape, and a solid state memory (including flash memory, DRAM, SRAM, a solid state drive)) can be employed as a computer-readable medium for the computer-executable instructions. The computer-executable instructions may be written to a computer-readable medium provided on a function-extension board inserted into the device or on a function-extension unit connected to the device, and a CPU provided on the function-extension board or unit may implement the operations of the above-described embodiments.

This disclosure has provided a detailed description with respect to particular explanatory embodiments. However, the scope of the appended claims is not limited to the above-described embodiments and includes various modifications and arrangements.

What is claimed is:

1. A method for clustering descriptors, the method comprising:
augmenting visual descriptors in a space of visual descriptors to generate augmented visual descriptors in an augmented space that includes semantic information, wherein the augmented space of the augmented descriptors includes both visual descriptor-to-descriptor dissimilarities and semantic label-to-label dissimilarities; and
clustering the augmented visual descriptors in the augmented space based at least in part on a dissimilarity measure between augmented visual descriptors in the augmented descriptor space.

2. The method of claim 1, further comprising determining a visual vocabulary based at least in part on the clusters of the augmented visual descriptors.

3. The method of claim 1, wherein images are associated with respective semantic labels, wherein each visual descriptor was extracted from a respective one of the images, and wherein, to generate augmented descriptors, the visual descriptors in the visual descriptor space are associated with the respective semantic labels that are associated with the respective one of the images from which the visual descriptors were extracted.

4. The method of claim 1, wherein regions of images are associated with respective semantic labels, wherein each visual descriptor was extracted from a respective one of the regions of the images, and wherein, to generate augmented descriptors, the visual descriptors in the visual descriptor space are associated with the respective semantic labels that are associated with the respective one of the regions of the images from which the visual descriptors were extracted.

5. The method of claim 1, where the semantic label-to-label dissimilarities indicate a distance based on a semantic ontology.

6. The method of claim 1, further comprising assigning candidate labels to one or more visual descriptors.

7. The method of claim 6, wherein the candidate labels are assigned to one or more unlabeled visual descriptors.

8. The method of claim 6, wherein augmenting visual descriptors, clustering the augmented visual descriptors, and assigning candidate labels are performed iteratively.

9. The method of claim 1, wherein the clustering is based at least in part on a Euclidean distance between the augmented visual descriptors.

10. The method of claim 1, further comprising reducing the dimensionality of the visual descriptor space based on the clusters of augmented visual descriptors in the augmented space, wherein the visual descriptors are clustered in the reduced dimensionality visual descriptor space.

11. The method of claim 1, further comprising agglomerating visual descriptor clusters in the visual descriptor space to form new visual descriptor clusters.

12. The method of claim 1, further comprising dividing visual descriptor clusters in the visual descriptor space to form new visual descriptor clusters.

13. A system for clustering descriptors, the system comprising:
a computer-readable medium configured to store visual descriptors; and
one or more processors configured to cause the system to
determine distances between the visual descriptors based on distances in visual dimensions and distances in semantic dimensions, and
cluster the visual descriptors based on the distances.

14. The system of claim 13, wherein the one or more processors are further configured to assign respective candidate semantic labels to the visual descriptors.

15. The system of claim 13, wherein, to determine distances between visual descriptors based on distances in visual dimensions and distances in semantic dimensions, the one or more processor are further configured to
determine distances between visual descriptors in a visual descriptor space, and
determine distances between visual descriptors in a semantic space.

16. The system of claim 13, wherein, to determine distances between visual descriptors based on distances in visual dimensions and distances in semantic dimensions, the one or more processor are further configured to
augment the visual descriptors in the visual dimensions with semantic information to generate augmented descriptors in augmented dimensions, wherein the visual dimensions define a visual space, and wherein the augmented dimensions define an augmented space that includes visual dimensions and semantic dimensions; and
determine the distances between the visual descriptors in the augmented space.

17. The system of claim 16, wherein the one or more processors are further configured to cluster the visual descriptors in the visual space based at least in part on the distances between the visual descriptors in the augmented space.

18. One or more computer-readable media storing instructions that, when executed by one or more computing devices, cause the one or more computing devices to perform operations comprising:
adding semantic information to visual descriptors, thereby generating augmented descriptors, wherein the visual descriptors are described by visual dimensions in a visual space, and the augmented descriptors are described by visual-semantic dimensions in an augmented space; and
clustering the augmented descriptors in the augmented space, thereby generating augmented descriptor clusters.

19. The one or more computer-readable media of claim 18, wherein the operations further comprise clustering the visual descriptors in the visual space based on the augmented descriptor clusters.

20. The one or more computer-readable media of claim 18, wherein the operations further comprise agglomerating two or more of the augmented descriptor clusters.

21. The one or more computer-readable media of claim 20, wherein the two or more of the augmented descriptor clusters are agglomerated based on a cluster quality score.
